(19) United States
(12) Patent Application Publication
(10) Pub. No.: US 2020/0000237 A1
(43) Pub. Date: Jan. 2, 2020

(54) FOLDABLE MASSAGE CHAIR

(71) Applicant: Dong-Her Wu, PUYEN HSIANG (TW)

(72) Inventor: Dong-Her Wu, PUYEN HSIANG (TW)

(21) Appl. No.: 16/153,790

(22) Filed: Oct. 7, 2018

(30) Foreign Application Priority Data
Jun. 29, 2018 (TW) 107122607

(51) Int. Cl. A47C 7/62; A61H 39/04; A47C 7/40; A47C 1/14

(52) U.S. Cl. CPC A47C 7/62; A61H 39/04; A47C 7/407; A61H 2201/0161; A61H 2201/0149; A61H 2205/081; A61H 2205/04; A47C 1/14

(57) ABSTRACT

A foldable massage chair has a foldable chair and a massaging mechanism. The massaging mechanism synchronizes the movement of the first and second massage units and the two moving members by driving the two primary shafts with a single motor, and the two moving members are equipped with the two driving gears with a passive gear engaging with the two belts. Therefore, there is no needs for rail structure, so that the massaging mechanism can be installed with the two belts in the foldable chair which can provide different reclining angles according to the characteristics of the folding chair. Moreover, the folding chair can be folded up, which is easy for storage.

### BACKGROUND OF INVENTION

### 1. Field of Invention

The present invention relates to a massage chair, and more particularly to a foldable massage chair.

### 2. Description of the Related Art

Accordingly, the conventional massaging mechanism, please refer to the FIGS. 13, 14, and 15, include: a primary body 30, a massaging member 40, a power unit 50 and two belts 60. The primary body 30 has a bottom portion 31, two fixing units 32 and a back portion 33. An inner surface of each fixing units 32 is provided with a track 321, two first rotating shafts 322 and a second rotating shaft 323. The massaging member 40 has a first driver 41, a first transmission shaft 42 and a massaging member 43 disposed on the first transmission shaft 42 which has a connecting block 44 at each of the side. The power unit 50 has a second driver 51, a second transmission shaft 52 and two gear sets 53. Each gear set 53 includes a driving gear 531 and at least two driven gears 532 that are engaged. The belts 60 continuously bypasses the driving gear 531 and the driven gear 532. The meshing portion, the two first rotating shafts 322, the second rotating shaft 323 and are looped together. Therefore, the two belts 60 are wrapped along the two track 321 and combined with the two connecting blocks 44 of the massaging member 40.

When the above-mentioned structure is operating, the massaging member 40 utilizes the first driver 41 to drive the massaging member 43, and then the gear set 53 of the power unit 50 engages with the belt 60 to move along the tracks 321 of the fixing unit 32. Therefore, the massaging member 40 sits across the two tracks 321 and is driven by the power unit 50 via the two belts 60 along the two tracks 321. When the user sits on the primary body 30, the massaging member 40 and the power device 50 are both activated, the power device 50 drives the massaging member 40 to perform massage along the thigh, buttocks, waist, back, shoulders and neck of the human body repeatedly. Alternatively, the massaging member 40 can be activated separately, so that the massaging member 40 stay at any position for massage enhancement. When the power unit 50 drives the massaging member 40, the engagement of the driving gear 531 and the driven gear 532 of the gear set 53 allows the belt 60 rotates along the track 321 and also drag the massaging member 40.

It is not difficult to find out the above-mentioned conventional structure has some shortcomings. The primary reasons are as follows: the massaging member 40 and the power unit 50 are respectively operated by the two drivers, and the belt 60 has to move along the tracks 321 and drag the massaging member 40, therefore the primary body 30 is preset with the track 321 which cannot be folded and store. Furthermore, the reclining angle of the back portion 33 of the primary body cannot be changed.

Therefore, it is desirable to provide a foldable massage chair to mitigate and/or obviate the aforementioned problems.

### SUMMARY OF THE INVENTION

An objective of present invention is to provide a foldable massage chair, which is capable of improving the above-mention problems.

In order to achieve the above mentioned objective, a foldable massage chair has: a foldable chair and a massaging mechanism. The massaging mechanism has a motor driving two primary shafts to move a first massaging unit and a second massaging unit. The massaging mechanism further has two moving members and two belts, and the two moving members are symmetrically disposed on two sides of the motor and having a box body containing two driving gears and a passive gear between the two driving gears. The two driving gears respectively engage with the two primary shafts, the passive gear is positioned in the box body via an axial pin. Two ends of the box body both having an opening allowing the belt to pass through and the two belts are placed in the box body of the two moving members in a zigzag manner among the two driving gears and the passive gear and disposed parallel with each other on the foldable chair.

Other objects, advantages, and novel features of invention will become more apparent from the following detailed description when taken in conjunction with the accompanying drawings.

### BRIEF DESCRIPTION OF DRAWINGS

FIG. 1 is a perspective view of a preferred embodiment according to the present invention.

FIG. 2 is an exploded view according to the preferred embodiment of the present invention.

FIG. 3 is a cross-sectional view according to the preferred embodiment of the present invention.

FIG. 4 is a schematic view showing the adjustment of the reclining angle according to the preferred embodiment of the present invention.

FIG. 5 is a side view of the adjusted reclining angle according to the preferred embodiment of the present invention.

FIG. 6 is a perspective view of the adjusted reclining angle of the preferred embodiment covered with a seat cover according to the present invention.

FIG. 7 is a schematic drawing showing the configuration state between the moving member and the belt according to the preferred embodiment of the present invention.

FIG. 8 is a schematic drawing of the massaging mechanism operating along the belt according to the preferred embodiment of the present invention.

FIG. 9 is a schematic drawing of the pivoting point of the massaging mechanism running along the belt according to the preferred embodiment of the present invention.

FIG. 10 is a partial enlarged schematic drawing of the massaging mechanism according to FIG. 9.

FIG. 11 is a schematic drawing of the folded state of the present invention.

FIG. 12 is a schematic view showing another embodiment of the mobile group of the present invention.

FIG. 13 is a perspective drawing of the prior art.

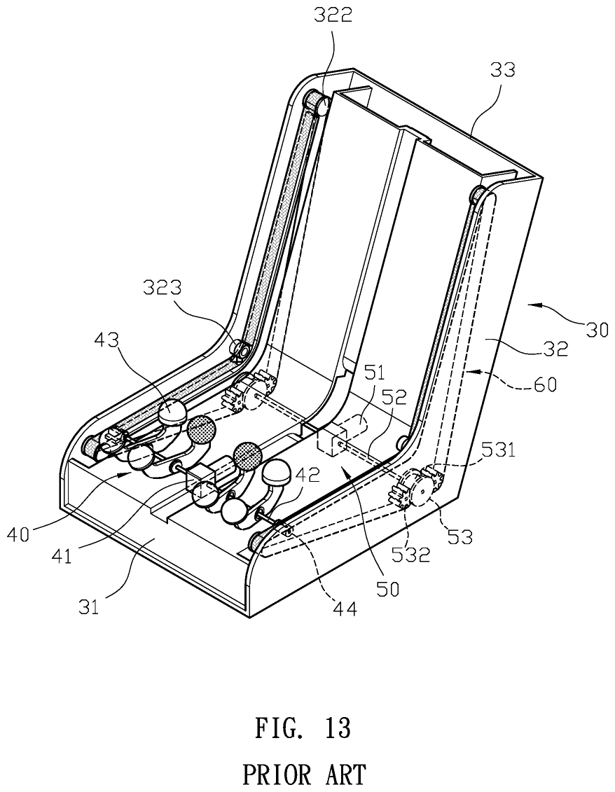

FIG. 14 is an exploded view of the prior art.

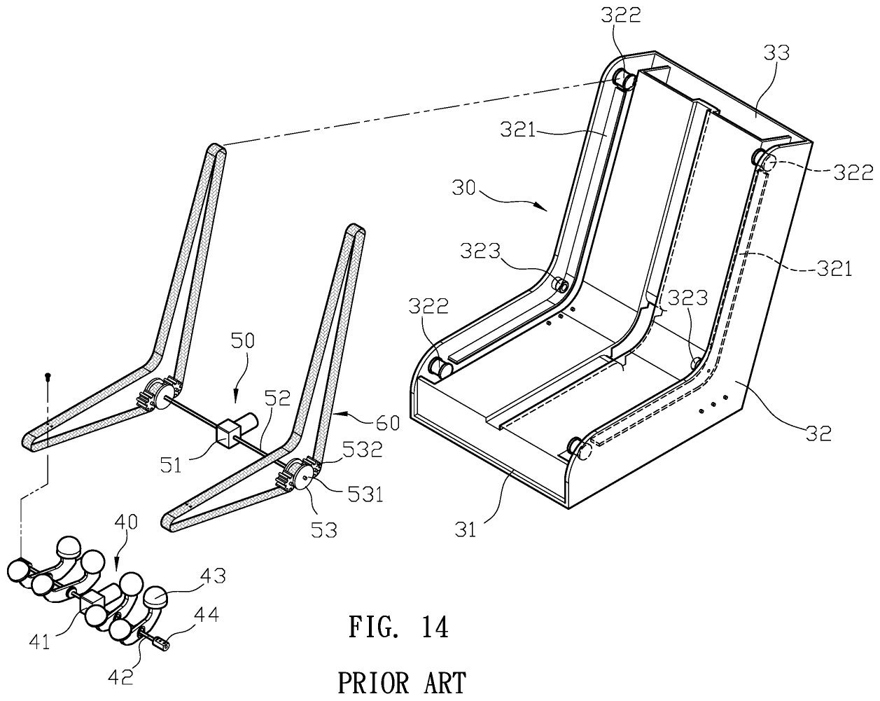

FIG. 15 is a schematic drawing of the operating state of the prior art.

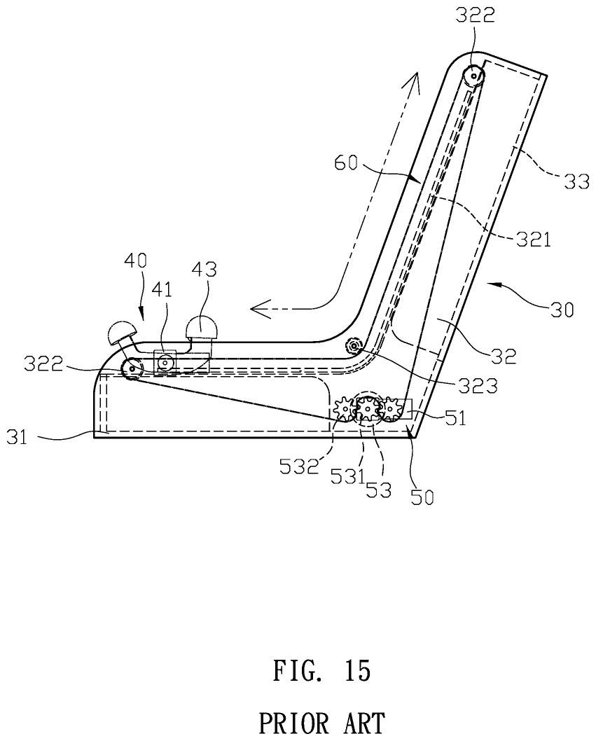

### DETAILED DESCRIPTION OF THE PREFERRED EMBODIMENT

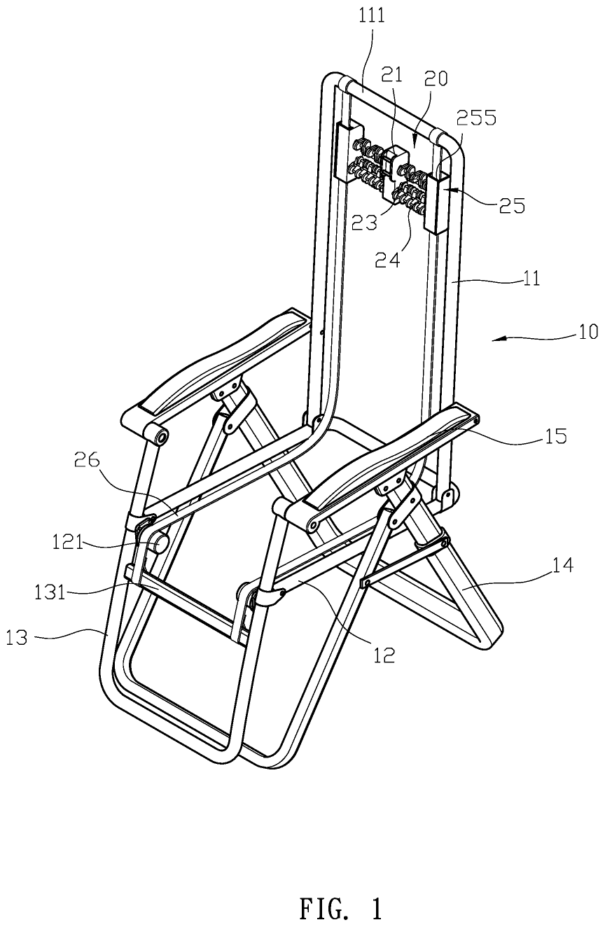

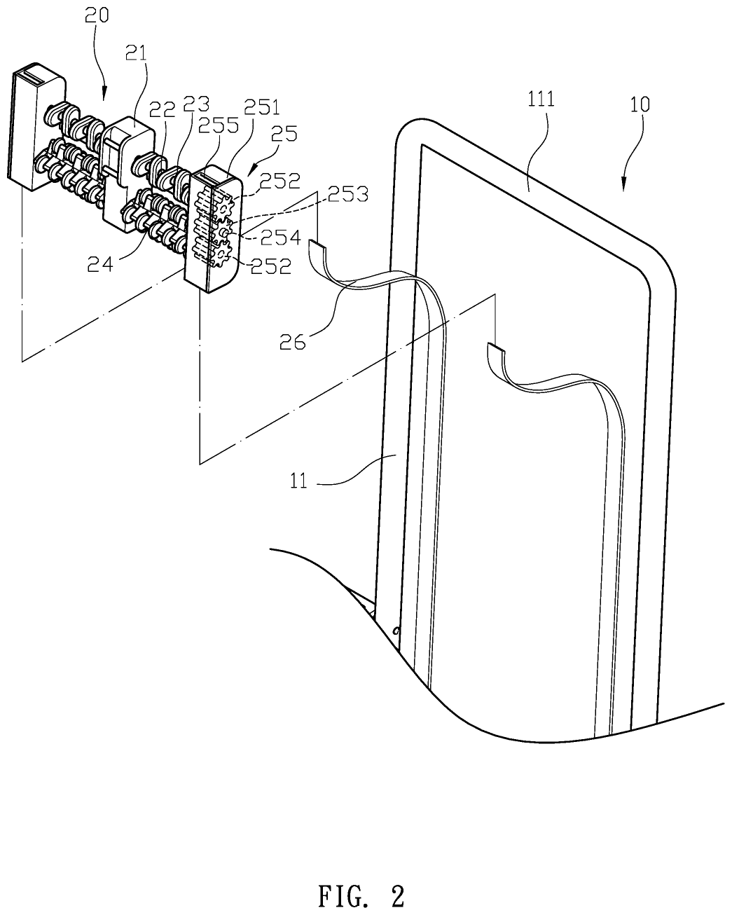

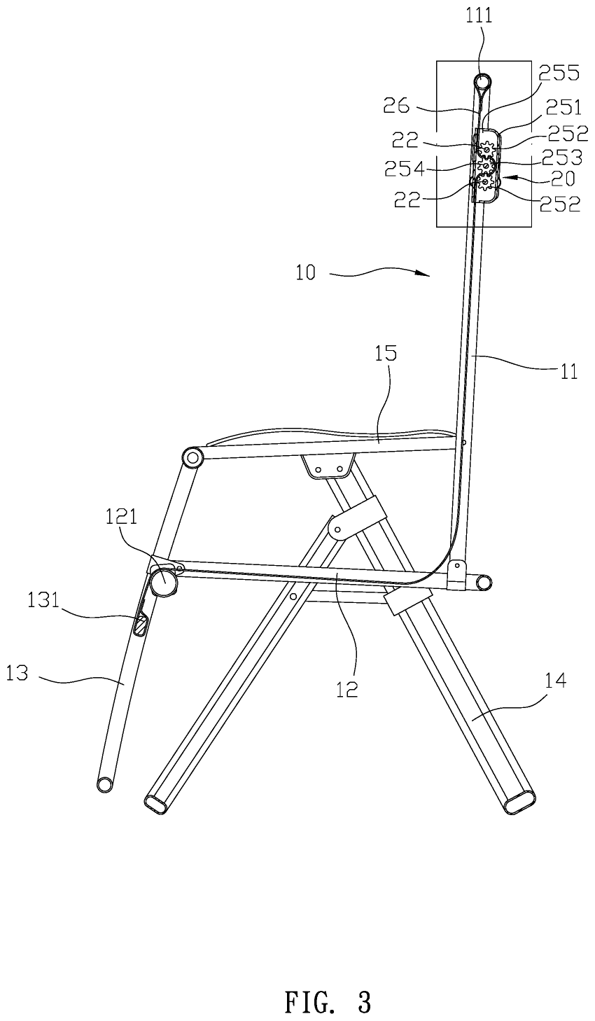

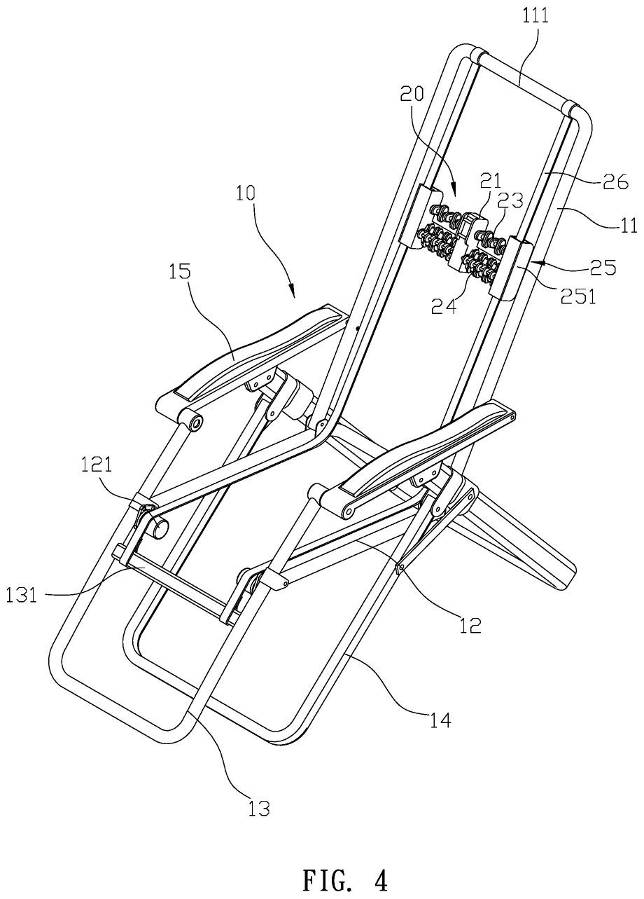

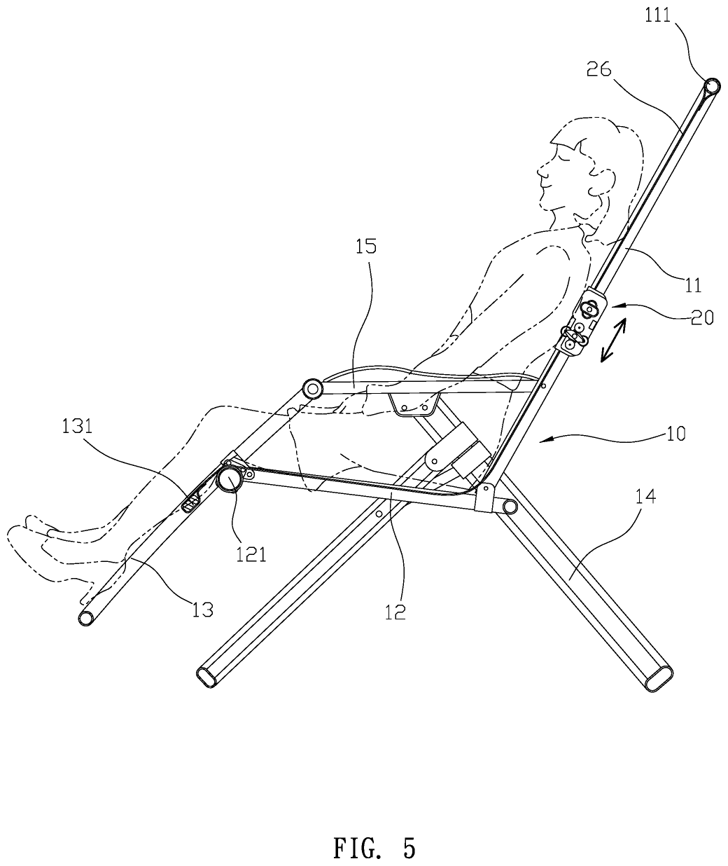

Please refer to FIG. 1, FIG. 2 and FIG. 3. A foldable massaging chair comprises: a foldable chair 10 and a massaging mechanism 20. The foldable chair 10 has a primary frame comprising a back portion 11, a seat portion 12 and a lower portion 13 and a supporting frame comprising a Y-shape stand 14 and the two armrest 15. Two ends of the two armrest 15 are respectively connected to the back portion 11 and the lower portion 13. Therefore, the back portion 11 and the lower portion 13 of the foldable chair 10 can be adjusted to have different inclined angles (as shown in FIGS. 4 and 5). A top end of the back portion 11 is further provided with a securing bar 111. The seat portion 12 and the lower portion 13 are symmetrically joined together by two pivoting points 121, the lower portion 13 further has a positioning bar 131 disposed lower than the two pivoting points 121. The massaging mechanism 20 comprising a motor 21 driving two primary shafts 22 to move a first massaging unit 23 and a second massaging unit 24 disposed at each side of the motor 21. The massaging mechanism 20 further comprising two moving members 25 and two belts 26, and the two moving members 25 are symmetrically disposed on two sides of the motor 21 and each has a box body 251 containing two driving gears 252 and a passive gear 253 between the two driving gear 252. The two driving gears 252 respectively engage with the two primary shafts 22, and the passive gear 253 is positioned in the box body 251 via an axial pin 254. Two ends of the box body 251 both have an opening 255 allowing the belt 26 to pass through.

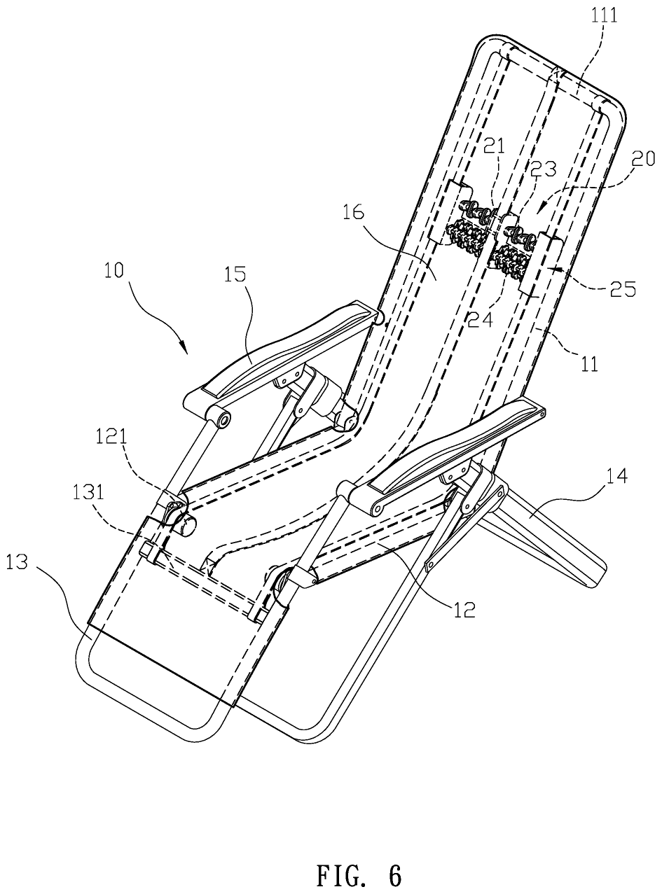

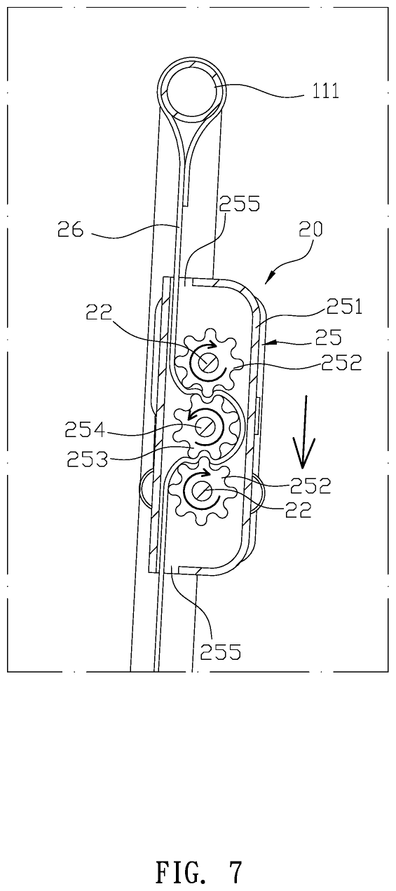

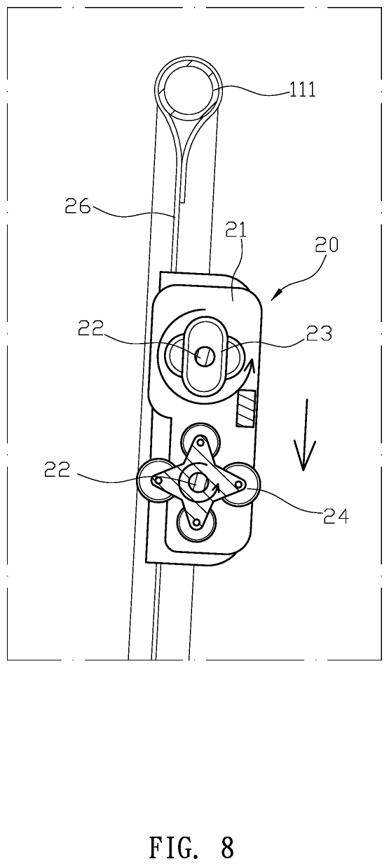

For the assembly of the massaging chair, please refer to FIGS. 1-3 with FIGS. 7-8. The two openings 255 of the box body of the two moving members 25 allows the belts 26 to pass through, and the two belts are placed in the box body 251 of the two moving members 255 in a zigzag manner among the two driving gears 252 and the passive gear 253. One end of each belts 26 is secured with the securing bar 111, and another end is secured with the positioning bar 131 along the primary frame and adjacent to the two pivoting point 121. Furthermore, another loose belt can be added between the back portion 11 and the seat portion 12 of the primary frame to limit the two belts 26 (not shown). The primary frame of the foldable chair 10 is covered with a supporting cover 16 (as shown in FIG. 6) which allows a user to sit or lay on the foldable chair 10, and the massaging mechanism 20 is covered in the foldable chair 10.

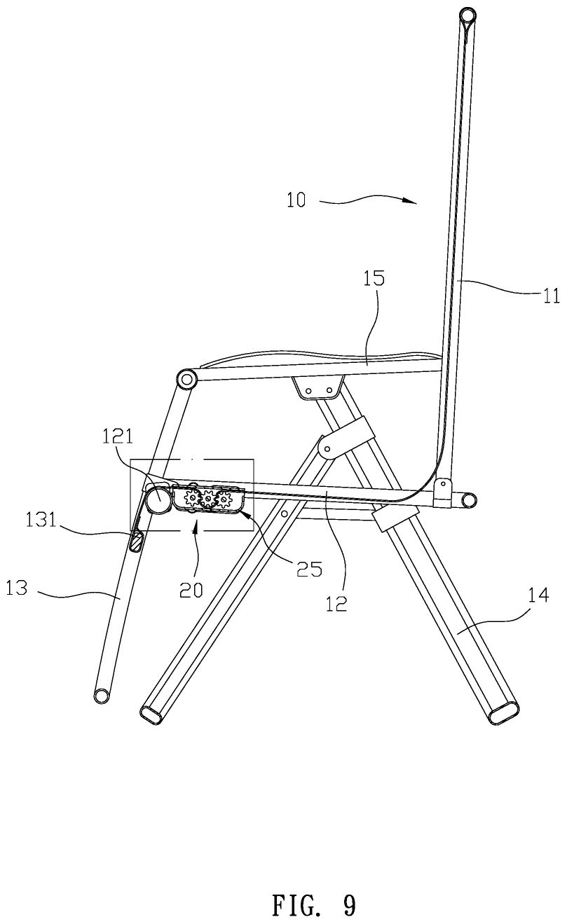

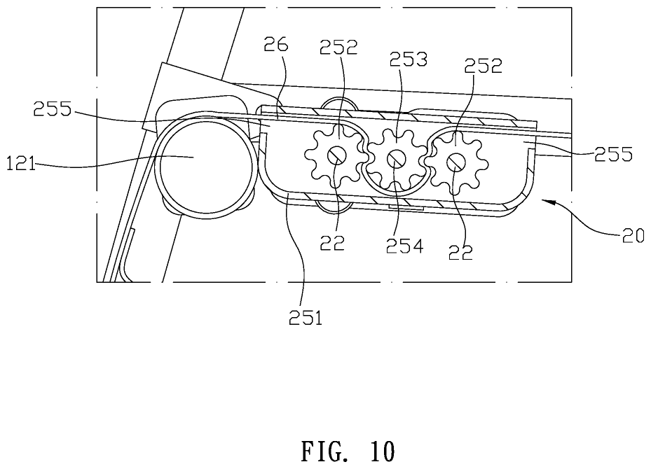

For actual operation, please refer to FIG. 3 with FIGS. 7-10. When the motor 21 of the massaging mechanism 20 is actuated, the motor 21 simultaneously drives the first and second massage units 23, 24 and the two driving gears 252 via the two primary shafts 22. When the driving gear 252 rotates, the passive gear 253 is driven to engage with the surface of the two belts 26 and then move along the two belts 26. Therefore, the massaging mechanism 20 is displaced from the securing bar 111 of the back portion 11 to the pivoting point 121 between the seat portion 12 and the lower portion 13. Through the simultaneous kneading movements of the first and second massage units 23, 24, the massaging effect is delivered to the back, waist and hips.

When the massaging mechanism 20 stops at the two pivoting point 121, the motor 21 reverses to bring the two moving members 25 moving along the two belts 26 from the pivoting point 121 back to the securing bar 111 of portion 11, thereby returning the massaging mechanism 20 to the home position while providing massaging effect to the user.

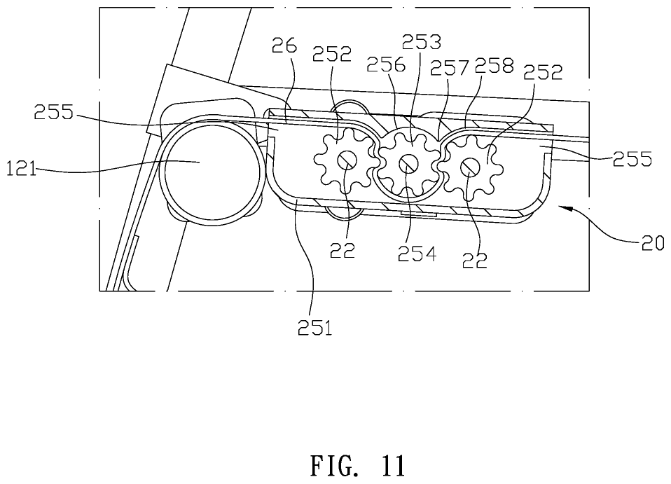

Another preferred embodiment of the moving member 25, as shown in FIG. 11. The moving member 25 is provided with an indented curve 256 at the center of the upper end surface inside the box body 251, both ends of the indented curve 256 extend downward to form a guiding protrusion 257, and a guiding curve 258 is formed by the two guiding protrusions 257 respectively extending to the two openings 255. The box body 251 is further provided with guiding ribs 259 along the two opening 255 inside, the indented curve 256 faces the passive gear 253, and the guiding curves 258 at two sides respectively face the two driving gears 252. When the belts 26 are introduced through the two opening 255 into the box body 251 and among the two driving gears 252 and the passive gear 253, the belts 26 can be supported not only just by the guiding ribs 259, but also limited between the two driving gears 252 and the guiding curve 258. Therefore, the belts 26 is accurately introduced among the two driving gears 252 and the passive gear 253 to improve the stability of the moving member 25 and achieve the smooth movement of the massaging mechanism 20.

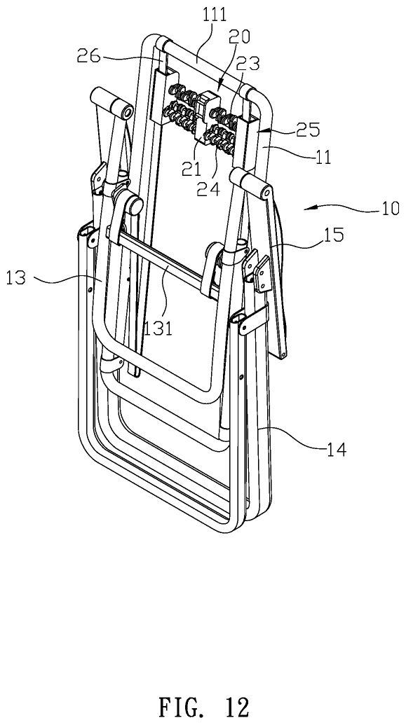

With the structure of the above embodiment, the following benefits can be obtained: The massaging mechanism 20 synchronizes the movement of the first and second massage units 23, 24 and the two moving members 25 by driving the two primary shafts 22 with a single motor 21, and the two moving members 25 are equipped with the two driving gears 252 with a passive gear 253 engaging with the two belts 26. Therefore, there is no needs for rail structure, so that the massaging mechanism 20 can be installed with the two belts 26 in the foldable chair 10 which can provide different reclining angles according to the characteristics of the folding chair 10. Moreover, the folding chair 10 can be folded up (as shown in FIG. 12), which is easy for storage.

Although the present invention has been explained in relation to its preferred embodiment, it is to be understood that many other possible modifications and variations can be made without departing from the spirit and scope of invention as hereinafter claimed.

What is claimed is:

1. A foldable massage chair comprising: a foldable chair and a massaging mechanism; the massaging mechanism comprising a motor driving two primary shafts to move a first massaging unit and a second massaging unit; the massaging mechanism further comprising two moving members and two belts, the two moving members symmetrically disposed on two sides of the motor and having a box body containing two driving gears and a passive gear between the two driving gears; the two driving gears respectively engaging with the two primary shafts, the passive gear positioned in the box body via an axial pin; two ends of the box body both having an opening allowing the belt to pass through; the two belts placed in the box body of the two moving members in a zigzag manner among the two driving gears and the passive gear and disposed parallel with each other on the foldable chair.

2. The foldable massage chair as claimed in claim 1, wherein the foldable chair has a primary frame comprising a back portion, a seat portion and a lower portion and a supporting frame comprising a Y-shaped stand and two armrests; two ends of the two armrests are respectively connected to the back portion and the lower portion, and the primary frame is further covered by the supporting cover.

3. The foldable massage chair as claimed in claim 2, wherein the seat portion and the lower portion are symmetrically joined together by two pivoting points, the lower portion further has a positioning bar disposed lower than the two pivoting points, a top end of the back portion is further provided with a securing bar; one end of the each belts is secured with the securing bar, and another end is secured with the positioning bar along the primary frame and adjacent to the two pivoting point.

4. The foldable massage chair as claimed in claim 1, wherein the moving member is further provided with an indented curve inside the box body, two ends of the indented curve respectively extending as guiding protrusions, the two guiding protrusions respectively extending towards the opening as a guiding curve; the box body is further provided with a guiding rib along the two openings; the indented curve faces the passive gear, and the two guiding curves respectively face the two driving gears.
